(19) United States
(12) Patent Application Publication
(10) Pub. No.: US 2019/0223013 A1
(43) Pub. Date: Jul. 18, 2019

(54) METHOD FOR ESTABLISHING PUBLIC DATA NETWORK CONNECTION AND RELATED DEVICE

(71) Applicant: HUAWEI TECHNOLOGIES CO., LTD., Shenzhen (CN)

(72) Inventors: Youyang Yu, Shanghai (CN); Huan Li, Shanghai (CN); Weisheng Jin, Shanghai (CN)

(73) Assignee: HUAWEI TECHNOLOGIES CO., LTD., Shenzhen (CN)

(21) Appl. No.: 16/368,639

(22) Filed: Mar. 28, 2019

Related U.S. Application Data
(63) Continuation of application No. PCT/CN2016/101415, filed on Sep. 30, 2016.

(51) Int. Cl. H04W 12/00; H04W 76/11; H04W 8/04; H04W 88/16

(52) U.S. Cl. CPC H04W 12/00516; H04W 88/16; H04W 8/04; H04W 76/11

(57) ABSTRACT

Embodiments of the present application disclose a method for establishing a PDN connection and a related device. The method may include: after UE is attached to a home network from a local network using an unlicensed spectrum, if the UE requests an EPC service, after an SeGW receives a PDN connection request message of the UE, establishing, by the SeGW, a secure channel with the UE, obtaining, by using a control plane network element, a PGW that corresponds to an APN requested by the UE, and establishing a session channel with the PGW, so that a PDN connection is established for the UE.

### CROSS-REFERENCE TO RELATED APPLICATIONS

This application is a continuation of International Application No. PCT/CN2016/101415, filed on Sep. 30, 2016, the disclosure of which is hereby incorporated by reference in its entirety.

### TECHNICAL FIELD

Embodiments of the present invention relate to the field of communications technologies, and specifically, to a method for establishing a public data network connection and a related device.

### BACKGROUND

Currently, an evolved packet system (Evolved Packet System, EPS) includes user equipment (User Equipment, UE), an access network, and an evolved packet core (Evolved Packet Core, EPC) network. A spectrum used in the access network is a licensed spectrum, for example, a universal terrestrial radio access network (Universal Terrestrial Radio Access Network, UTRAN) and an evolved universal terrestrial radio access network (Evolved UTRAN, E-UTRAN). With development of mobile broadband businesses, a licensed spectrum gradually cannot meet a rapidly growing service demand, and use of an unlicensed spectrum as a new radio access technology becomes a development trend of an EPS access network to improve a bearing capability of an air interface.

In practice, it is found that when UE is attached to a home operator EPC from an access network, the home operator EPC establishes a public data network (Public Data Network, PDN) connection for the UE, to implement “always-on” of the UE. However, in a network architecture in which a local network using an unlicensed spectrum accesses a home operator EPC, after UE is attached to the home operator EPC, only a local service may need to be performed, and if the UE is always on after the UE is attached to the home operator EPC, resources of the EPC network are occupied. Consequently, utilization of EPC network resources is reduced.

### SUMMARY

Embodiments of the present invention disclose a method for establishing a PDN connection, a related device, and a system, to establish a PDN connection for UE when the UE accesses an EPC from an unlicensed spectrum.

A first aspect of the embodiments of the present invention discloses a method for establishing a PDN connection, where the method is applied to an EPS. The method may include:

when UE accesses from a local network using an unlicensed spectrum, after a security gateway (Security Gateway, SeGW) receives a first request message that is sent by a local network device and that is used to request to establish a PDN connection for the UE, obtaining, by the security gateway, a radio access technology indication of the UE and an identifier of a control plane network element to which the UE is attached; and sending a second request message to the control plane network element based on the identifier of the control plane network element, where the second request message carries a subscriber identity and the radio access technology indication of the UE, and is used to request to obtain an identifier of a data gateway (packet Data Network Gateway, PGW), so that after receiving the second request message, the control plane network element may send the identifier of the PGW to the SeGW based on the subscriber identity and the radio access technology indication. Therefore, the SeGW may send, based on the identifier of the PGW, a third request message to a corresponding PGW, to request to establish a session channel connection between the SeGW and the PGW. The SeGW may then receive a response from the PGW of establishing the session channel connection to the SeGW based on the third request message.

The first request message is sent by the UE to the local network device, to request to establish a PDN connection for the UE. The PDN connection of the UE includes a secure channel connection between the UE and the SeGW and the session channel connection between the SeGW and the PGW.

Specifically, the first request message may be an access point name (Access Point Name, APN) connection request message or may be a PDN connection request message, the second request message may be a PDN connection establishment request message, and the third request message may be a session establishment request message. After receiving the second request message, the PGW establishes a session channel connection to the SeGW. In addition, the PGW allocates an IP address to the UE, and allocates a tunnel, a quality of service (Quality of Service, QoS) parameter, and the like for the PDN connection, and records that the current PDN connection is an unlicensed spectrum access.

After the UE is attached to a home network, the UE triggers establishment of a PDN connection when there is an EPC service demand, thereby avoiding occupation of EPC network resources when no EPC service is required, and improving utilization of the EPC network resources.

Optionally, a specific manner in which the SeGW obtains the radio access technology indication of the UE may include the following two types.

Manner 1

When forwarding the first request message, the local network device carries the radio access technology indication indicating that a RAT used by the UE is an unlicensed spectrum access technology. After receiving the first request message, the SeGW may obtain the radio access technology indication from the first request message.

Manner 2

When forwarding the first request message, the local network device carries information about a radio access node of the local network, where the information indicates that the radio access node is an unlicensed spectrum radio access node. Therefore, after receiving the first request message, the SeGW may determine, based on the information about the radio access node, that a RAT used by the UE is an unlicensed spectrum access technology, and generate the radio access technology indication.

Optionally, a specific manner in which the SeGW obtains the identifier of the control plane network element to which the UE is attached may include the following several types.

Manner 1

When forwarding the first request message, the local network device carries a temporary identifier allocated by a home network to the UE, where the temporary identifier includes the identifier of the control plane network element to which the UE is attached. After receiving the first request message, the SeGW may obtain the identifier of the control plane network element to which the UE is attached from the temporary identifier. Alternatively, when forwarding the first request message, the local network device directly carries the identifier of the control plane network element to which the UE is attached, and the SeGW directly obtains the identifier of the control plane network element to which the UE is attached from the first request message.

Manner 2

When forwarding the first request message, the local network device carries a local IP address allocated by the local network device to the UE. After receiving the first request message, the SeGW may send, to the local network device, a request message used to request to obtain the identifier of the control plane network element to which the UE is attached, for example, a connection information request message, where the message carries the local Internet Protocol (Internet Protocol, IP) address of the UE. After receiving the connection information request message, the local network device looks up context of the UE based on the local IP address of the UE, to send, to the SeGW by using a connection information reply message, an identifier that is of a control plane network element to which the UE is currently attached and that is included in the context of the UE.

Manner 3

After receiving the first request message, the SeGW may send, to a home subscriber server (Home Subscriber Server, HSS), a request message used to request to obtain the identifier of the control plane network element to which the UE is attached, for example, an update location request message, where the message includes a permanent identity of the UE, for example, an international mobile subscriber identity (International Mobile Subscriber Identity, IMSI). The HSS looks up context of the UE based on the IMSI of the UE. If the UE is already attached to the control plane network element, the HSS stores an identifier of a control plane network element to which the UE is currently attached, to reply to the SeGW with an update location reply message, where the message carries the identifier of the control plane network element to which the UE is attached.

Optionally, the method may further include:

when service continuity needs to be maintained when the UE moves, receiving, by the SeGW, an indication message that is sent by the control plane network element and that is used to instruct the SeGW to feed back a result of establishing the session channel connection to the PGW, and sending connection information of the session channel connection to the control plane network element after establishing the session channel connection to the PGW.

The indication message may be an Acknowledge (Acknowledge, ACK)-needed indication, or may be a handover (Handover, HO)-supported indication, or may further be a service continuity indication. The connection information may include at least one of a tunnel endpoint identifier (Tunnel Endpoint Identifier, TEID) that is allocated by the PGW to the session channel connection, and the IP address or QoS of the UE.

Optionally, the receiving, by the SeGW, the identifier that is of the PGW and that is returned by the control plane network element based on the subscriber identity and the radio access technology indication includes:

if the first request message carries an APN requested by the UE, where the requested APN is an APN in the radio access technology indication, and the second request message sent by the SeGW to the control plane network element also carries the requested APN, receiving, by the SeGW, an identifier that is returned by the control plane network element after the control plane network element performs authorization on the requested APN based on the subscriber identity and that is of a PGW that corresponds to the successfully-authorized APN; or

if the first request message does not carry an APN requested by the UE, receiving, by the SeGW, an identifier that is returned by the control plane network element based on the subscriber identity and the radio access technology indication and that is of an APN that corresponds to a default APN in subscription data of the UE.

In a process of establishing a PDN connection for the UE, the UE directly establishes a secure channel with the SeGW, and then the SeGW searches for a control plane network element. In this way, the UE and the SeGW may communicate with each other by using the secure channel. A local network deployed by a third party cannot see communication content, and therefore an operator service is protected.

A second aspect of the embodiments of the present invention discloses a security gateway. The security gateway may include a transceiver module and a processing module, and may be configured to perform the method for establishing a PDN connection disclosed in the first aspect.

A third aspect of the embodiments of the present invention discloses another security gateway. The security gateway may include a transceiver and a processor. The transceiver corresponds to the transceiver module of the security gateway disclosed in the second aspect, the processor corresponds to the processing module of the security gateway disclosed in the second aspect, and the security gateway may be configured to perform the method for establishing a PDN connection disclosed in the first aspect.

A fourth aspect of the embodiments of the present invention discloses another method for establishing a PDN connection, where the method is applied to an EPS. The method may include:

when UE accesses from a local network using an unlicensed spectrum, receiving, by a control plane network element, a second request message sent by an SeGW, and sending an identifier of a PGW to the SeGW based on a subscriber identity and a radio access technology indication that are of the UE and that are carried in the second request message, so that the SeGW establishes a session channel connection to a PGW identified by the identifier of the PGW corresponding to an APN.

The second request message is used to request to obtain the identifier of the PGW, and the second request message carries the subscriber identity and the radio access technology indication of the UE. The radio access technology indication is used to indicate that a radio access technology used by the UE is an unlicensed spectrum access technology. The second request message is sent to the control plane network element by the SeGW after the SeGW receives a first request message of the UE and establishes a secure channel connection to the UE. The first request message is used to request to establish a PDN connection for the UE, where the PDN connection includes a secure channel connection and a session channel connection.

Specifically, the first request message may be an APN connection request message or may be a PDN connection request message, and the second request message may be a PDN connection establishment request message.

Further, when the PGW establishes the session channel connection to the SeGW, the PGW allocates an IP address to the UE, and allocates a tunnel, a QoS parameter, and the like to the PDN connection, and records that the current PDN connection is an unlicensed spectrum access.

Optionally, a specific manner in which the control plane network element sends the identifier of the PGW to the SeGW based on the subscriber identity and the radio access technology indication may be:

obtaining subscription data of the UE based on the subscriber identity, and performing APN authorization based on the subscription data and the radio access technology indication, to send an identifier of a PGW corresponding to the successfully-authorized APN to the SeGW.

After receiving a PDN connection establishment request message sent by the SeGW, the control plane network element may first perform authorization on an APN requested by the UE, and send, only when the authorization succeeds, an identifier of a PGW corresponding to the successfully-authorized APN to the SeGW. Therefore, the SeGW establishes the session channel connection to the PGW, so that after the UE is attached to a home network, a PDN connection is established for the UE only when the UE has a demand, thereby avoiding occupation of EPC network resources, and improving utilization of the EPC network resources.

In a specific implementation, a specific manner in which the control plane network element performs the APN authorization based on the subscription data and the radio access technology indication may include any one of the following types.

Manner 1

If the second request message carries an APN requested by the UE, where the requested APN is an APN in the radio access technology indication, the control plane network element determines whether the subscription data includes the radio access technology indication, and if the subscription data includes the radio access technology indication, the control plane network element determines that the requested APN is successfully authorized, or if the subscription data does not include the radio access technology indication, the control plane network element determines that the requested APN fails to be authorized.

Manner 2

The control plane network element determines whether the subscription data includes the radio access technology indication, and if the subscription data includes the radio access technology indication, the control plane network element determines that a default APN in the subscription data is successfully authorized, or if the subscription data does not include the radio access technology indication, the control plane network element determines that the default APN in the subscription data fails to be authorized.

Optionally, a specific manner in which the control plane network element sends the identifier of the PGW corresponding to the successfully-authorized APN to the SeGW may include the following two types.

Manner 1

If the third request message carries location information of the UE, after authorization performed by the control plane network element on the APN succeeds, the control plane network element may send, to the SeGW based on the location information of the UE, an identifier of a PGW that is in PGWs corresponding to the successfully-authorized APN and that is closest to the UE.

Manner 2

The control plane network element may obtain load information of each PGW, and after authorization performed on an APN succeeds, send, to the SeGW based on the load information of each PGW, an identifier of a PGW that is in PGWs corresponding to the successfully-authorized APN and whose load is the lightest.

The identifier of the PGW that is closest to the UE or whose load is the lightest and that is in the PGWs corresponding to the successfully-authorized APN is sent to the SeGW, so that the SeGW establishes a session channel connection to the PGW that is closest to the UE or whose load is the lightest, and therefore utilization of network resources can be improved.

Optionally, the method may further include:

sending, by the control plane network element, an indication message to the SeGW, where the indication message is used to instruct the SeGW to feed back a result of establishing the session channel connection to the PGW, so that the control plane network element may receive connection information that is about the session channel connection and that is sent by the SeGW after the SeGW establishes the session channel connection to the PGW.

A fifth aspect of the embodiments of the present invention discloses a control plane network element. The control plane network element may include a transceiver module and a processing module, and may be configured to perform the method for establishing a PDN connection disclosed in the fourth aspect.

A sixth aspect of the embodiments of the present invention discloses another control plane network element. The control plane network element may include a transceiver and a processor. The transceiver corresponds to the transceiver module of the control plane network element disclosed in the fifth aspect, the processor corresponds to the processing module of the control plane network element disclosed in the fifth aspect, and the control plane network element may be configured to perform the method for establishing a PDN connection disclosed in the fourth aspect.

A seventh aspect of the embodiments of the present invention discloses UE, where the UE is applied to an EPS. After authorization performed on the UE of accessing from an unlicensed spectrum succeeds, a home network may send an identifier of an SeGW to the UE, for example, an IP address or a fully qualified domain name/absolute domain name (Fully Qualified Domain Name, FQDN) of the SeGW. The UE may receive the identifier of the SeGW. In this way, when sending a first request message to a local network device, the UE may carry the identifier of the SeGW.

Further, the local network device may further allocate a local IP address to the UE. After the access authorization succeeds, the UE may further receive the local IP address sent by the local network device.

An eighth aspect of the embodiments of the present invention discloses a local network device, where the local network device is applied to an EPS. A first request message that is received by the local network device and sent by UE may further carry an identifier of an SeGW, that is, a source address of the first request message is set to a local IP address allocated by the local network device to the UE, and a destination address is an IP address that corresponds to the SeGW and that is received by the UE.

A ninth aspect of the embodiments of the present invention discloses a system for establishing a PDN connection. The system is applied to an EPS system and may include the SeGW disclosed in the second aspect, the control plane network element disclosed in the fifth aspect, the local network device disclosed in the eighth aspect, the UE and the PGW disclosed in the seventh aspect, and the like. By using the system, after the UE is attached to a home network from a local network using an unlicensed spectrum, a PDN connection is established for the UE only when the UE has a demand of an EPC service, thereby avoiding occupation of EPC network resources, and improving utilization of the EPC network resources. Further, in a process of establishing a PDN connection for the UE, the UE directly establishes a secure channel with the SeGW, and then the SeGW searches for a control plane network element. In this way, the UE and the SeGW may communicate with each other by using the secure channel. A local network deployed by a third party cannot see communication content, and therefore an operator service is protected.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and a person of ordinary skill in the art may derive other drawings from these accompanying drawings without creative efforts.

FIG. 1 is a schematic diagram of an EPS architecture according to an embodiment of the present invention;

FIG. 2 is a schematic flowchart of a method for establishing a PDN connection according to an embodiment of the present invention;

FIG. 3 is a schematic structural diagram of a security gateway according to an embodiment of the present invention;

FIG. 4 is a schematic structural diagram of another security gateway according to an embodiment of the present invention;

FIG. 5 is a schematic structural diagram of a control plane network element according to an embodiment of the present invention;

FIG. 6 is a schematic structural diagram of another control plane network element according to an embodiment of the present invention; and

FIG. 7 is a schematic structural diagram of a system for establishing a PDN connection according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

The embodiments of the present invention disclose a method for establishing a PDN connection, a related device, and a system, to improve utilization of EPC network resources. Detailed descriptions are separately provided below.

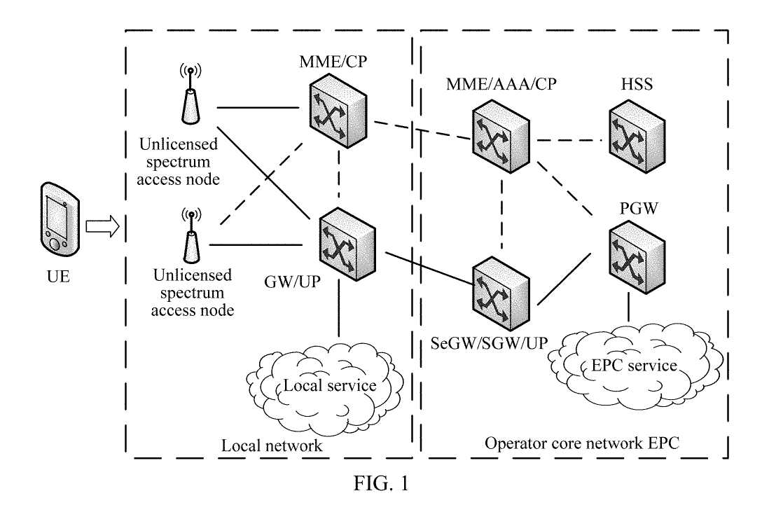

To better understand the method for establishing a PDN connection and the related device disclosed in the embodiments of the present invention, the following first describes an EPS architecture applicable to the embodiments of the present invention. FIG. 1 is a schematic diagram of an EPS architecture according to an embodiment of the present invention. The system architecture shown in FIG. 1 includes UE, a local network, and an operator core network EPC. The UE may include a handheld device that has a wireless communication function, an in-vehicle device, a wearable device, a computing device, or another processing device connected to a wireless modem, and user equipment, a mobile station (Mobile station, MS), a terminal (terminal), a terminal device (Terminal Device) that are of various forms, and the like. For ease of description, in the embodiments of the present invention, the devices mentioned above are all referred to as user equipment or UE.

The system architecture shown in FIG. 1 is applied to a roaming scenario. In FIG. 1, the local network is a network deployed by a third party and is distinguished from an operator network. The local network includes an unlicensed spectrum radio access node (for example, a Wi-Fi access node and an LTE in unlicensed spectrum (LTE in unlicensed spectrum, LTE-U) access node, briefly referred to as an LTE-U access node), a control plane network element of the local network, and a user plane network element of the local network. The LTE-U access node refers to a base station, an access point (Access Point, AP), or the like that uses an unlicensed spectrum. The control plane network element of the local network is a mobility management entity (Mobility Management Entity, MME) or a control plane (Control Planet, CP) node. The user plane network element of the local network is a gateway (Gateway, GW) or a user plane (User Plane, UP) node. An operator EPC includes a control plane network element, a user plane network element, an HSS, and a PGW. The control plane network element is an MME, an authentication, authorization, and accounting (Authentication, Authorization, Accounting, AAA) server, an evolved packet data gateway (Evolved Packet Data Gateway, ePDG), a serving general packet radio service (General Packet Radio Service, GPRS) GPRS support node (Serving GPRS Support Node, SGSN), or a CP. The user plane network element includes an SeGW, a serving gateway (Serving Gateway, SGW), or a UP. This is not limited in this embodiment of the present invention.

It should be noted that, the local network device mentioned in this embodiment of the present invention is the control plane network element of the local network, and the control plane network element mentioned in this embodiment of the present invention is the control plane network element of the operator EPC. This is not described in this embodiment of the present invention again.

In the system architecture shown in FIG. 1, when the UE accesses a home operator EPC from an unlicensed spectrum access node of the local network, the home operator EPC needs to perform access authorization on the UE, that is, to determine whether to allow the UE to access a home network to which the UE belongs from the unlicensed spectrum access node. If the home operator EPC allows the UE to access from the unlicensed spectrum access node of the local network, the UE may initiate a local service by using the local network, or may initiate an EPC service (that is, a home operator core network service). The system architecture shown in FIG. 1 uses the unlicensed spectrum as a new radio access technology, and therefore can improve a bearing capability of an air interface of the network of the system.

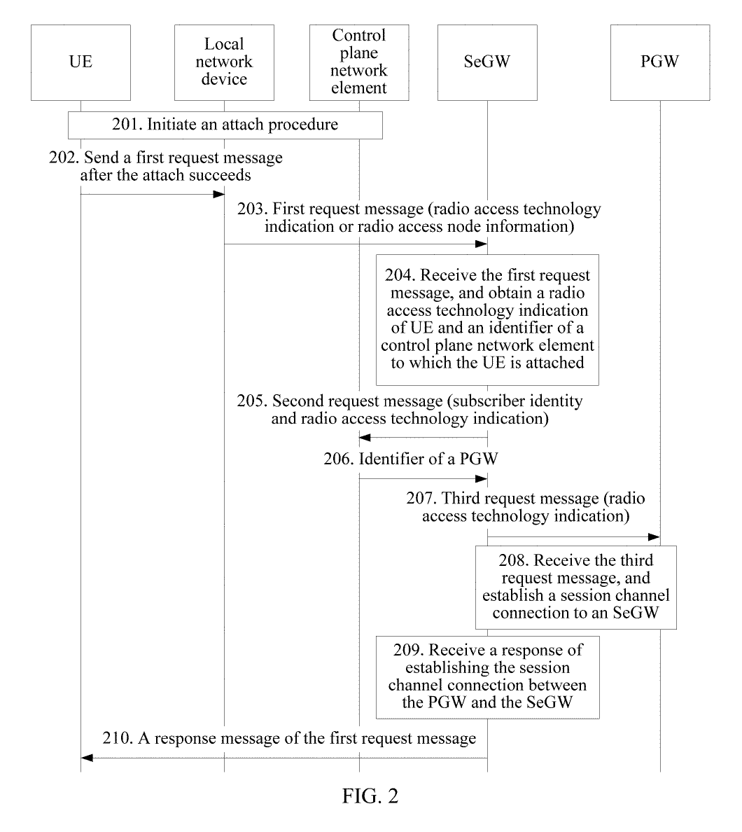

Based on the system architecture shown in FIG. 1, an embodiment of the present invention discloses a method for establishing a PDN connection. FIG. 2 is a schematic flowchart of a method for establishing a PDN connection according to an embodiment of the present invention. As shown in FIG. 2, the method for establishing a PDN connection may include the following steps.

201. UE initiates an attach procedure by using a local network that uses an unlicensed spectrum.

In this embodiment of the present invention, when the UE is initially attached to a home network, the UE searches for and finds an unlicensed spectrum network, and therefore the UE sends an attach request message to an unlicensed spectrum access node. The unlicensed spectrum access node may be an LTE-U access node, a Wi-Fi access node, and the like. The unlicensed spectrum access node forwards the attach request message to the local network device, and the local network device generates routing information based on an identifier that is of the home network and that is carried in the attach request message and a network topology, to route the attach request message to a control plane network element, for example, an MME, of the home network. When routing the attach request message to the control plane network element, the local network device may further send, to the control plane network element, access information of the UE accessing the home network from the unlicensed spectrum access node, such as characteristic information of the local network, characteristic information of the unlicensed spectrum access node, location information of the UE, and current time information.

The characteristic information of the local network includes security authentication information used by the local network, for example, at least one of an identifier of a used security authentication scheme and the like, an identifier of a service provider to which the local network belongs, a roaming consortium identifier, or a type of a radio access technology (Radio Access Technology, RAT) used by the local network. The RAT is an unlicensed spectrum access. The characteristic information of the unlicensed spectrum access node includes at least one of an access mode (for example, an open mode, a closed mode, and a mixed mode) or a security level of the unlicensed spectrum access node.

Further, after receiving the attach request message and access information of the UE, the control plane network element stores the access information, and sends a update location request message to an HSS based on the attach request message, to update the control plane network element that provides a service to the UE. In addition, the control plane network element further sends the radio access technology indication indicating the unlicensed spectrum access used by the UE or the identifier of the service provider to which the local network belongs, the roaming consortium identifier, and the like to the HSS, so that after the HSS finds subscription data of the UE based on the subscriber identity (for example, a permanent identity) of the UE, the HSS may initially perform access authorization on the UE based on the subscription data of the UE, that is, determine whether to allow the UE to access the home network from the unlicensed spectrum access node (the unlicensed spectrum network), and whether to allow the UE to access the home network from the service provider or an unlicensed spectrum network deployed by a roaming consortium member, and the like.

Further, when the access authorization initially performed by the HSS on the UE succeeds, the subscription data of the UE is sent to the control plane network element, and the control plane network element performs access authorization on the UE again based on the subscription data. For example, the control plane network element determines whether a current time or place allows the UE to access the home network from the unlicensed spectrum access node, whether the access mode or security level of the unlicensed spectrum access node meets a condition that allows the UE to access the home network from the unlicensed spectrum access node, whether the local network is a trusted or an untrusted network, and whether the home network allows the UE to access from a trusted network or an untrusted network. This is not limited in this embodiment of the present invention.

In this embodiment of the present invention, if the foregoing conditions all allow the UE to access the home network from the unlicensed spectrum access node, it indicates that authorization of the UE to access the home network from the unlicensed spectrum access node succeeds, that is, the UE is successfully attached.

In addition, the control plane network element may further determine, based on the subscription data and the characteristic information of the local network, whether there is an authorized APN in the subscription data, that is, determine whether the characteristic information of the local network matches an authorization condition of the APN. If the characteristic information of the local network matches the authorization condition of the APN, the control plane network element selects an SeGW based on the location information of the UE, a load request of a network, or information about a subscription APN, for example, selects an SeGW that is close to the UE, or an SeGW whose load is relatively light, or an SeGW corresponding to the subscription APN, to send an identifier of the SeGW (for example, an IP address or an FQDN of the SeGW or a correspondence between the APN and the SeGW to the UE. If the characteristic information of the local network does not match the authorization condition of the APN, it indicates that there is no authorized APN, and the control plane network element does not allocate an identifier of the SeGW to the UE.

For example, assuming that the local network is an untrusted network, and a belonging service provider is A, the control plane network element may determine that an authorization condition of the subscription APN is whether to allow the UE to access from an untrusted network, or whether to allow the UE to access from a local network deployed by the service provider A, or whether to allow the used RAT to be the unlicensed spectrum access, or the like. If the authorization condition is met, the control plane network element determines that the subscription APN is an authorization APN, or determines that authorization of the subscription APN succeeds.

Further, after successfully performing authorization on the UE, the control plane network element may further generate a local service policy of the UE based on the subscription data of the UE, to send the local service policy to the local network device, and the local network device may perform service authorization on a local service request of the UE by using the local service policy. After receiving an access allowance indication sent by the control plane network element, the local network device allocates a local IP address to the UE and forwards an attach reply message. The attach reply message carries a temporary identifier allocated by the home network to the UE, an identifier that is of an SeGW and that is allocated to the UE, or an authorization APN and an identifier of an SeGW corresponding to the authorization APN. This is not limited in this embodiment of the present invention.

202. After the UE is successfully attached, the UE sends a first request message to a local network device.

In this embodiment of the present invention, after the UE is successfully attached (that is, attached to the control plane network element of the home network), if the UE needs to initiate a local service, the UE only needs to send a local service request to the local network device, and the local network device may perform service authorization on the local service request based on the local service policy. If the UE needs to initiate an EPC service, the UE may send a first request message to the local network device. The first request message is used to request to establish a PDN connection for the UE. The PDN connection of the UE includes a secure channel connection between the UE and the SeGW and a session channel connection between the SeGW and the PGW. The first request message may be a PDN connection request message, or may be an APN connection request message. This is not limited in this embodiment of the present invention.

Specifically, the sending, by the UE, the first request message to the local network device may be specifically sending the first request message to the unlicensed spectrum access node, and then forwarding the first request message to the local network device by using the unlicensed spectrum access node.

In this embodiment of the present invention, when the first request message is an APN connection request message, the message may be specifically an IKE_AUTH request message, a source address of the message is set to the local IP address allocated by the local network device to the UE, and a destination address is an IP address that is received by the UE and that corresponds to the SeGW. When the first request message is a PDN connection request message, the message carries an identifier of an SeGW, for example, an IP address and an FQDN of the SeGW, and the message includes an Internet Key Exchange Protocol Version 2 (Internet Key Exchange Protocol Version 2, IKEv2) message that is related to establishment of a secure channel connection between the UE and the SeGW, for example, an IKE_AUTH request message or an IKE_SA_INIT message.

203. The local network device forwards the first request message to an SeGW.

In this embodiment of the present invention, when the first request message is an APN connection request message, after receiving the APN connection request message, the local network device routes the APN connection request message to a corresponding SeGW based on a destination address. When the first request message is a PDN connection request message, the local network device needs to support a control plane message, parse out an IP address of an SeGW from the PDN connection request message, and send the PDN connection request message to the corresponding SeGW based on the IP address.

204. The SeGW receives the first request message, and obtains a radio access technology indication of the UE and an identifier of a control plane network element to which the UE is attached.

In this embodiment of the present invention, if the SeGW receives the first request message, it indicates that a secure channel connection between the SeGW and the UE is successfully established. Further, after receiving the first request message, the SeGW obtains a radio access technology indication of the UE. The radio access technology indication is used to indicate that the RAT used by the UE is an unlicensed spectrum access technology.

Further, after receiving the first request message, the SeGW may further obtain the identifier of the control plane network element to which the UE is attached.

Specifically, a specific manner in which the SeGW obtains the identifier of the control plane network element to which the UE is attached may include the following several types.

Manner 1

When forwarding the first request message, the local network device carries a temporary identifier allocated by a home network to the UE, where the temporary identifier includes the identifier of the control plane network element to which the UE is attached. After receiving the first request message, the SeGW may obtain the identifier of the control plane network element to which the UE is attached from the temporary identifier. Alternatively, when forwarding the first request message, the local network device directly carries the identifier of the control plane network element to which the UE is attached, and the SeGW directly obtains the identifier of the control plane network element to which the UE is attached from the first request message.

Manner 2

When forwarding the first request message, the local network device carries a local IP address allocated by the local network device to the UE. After receiving the first request message, the SeGW may send, to the local network device, a request message used to request to obtain the identifier of the control plane network element to which the UE is attached, for example, a connection information request message, where the message carries the local IP address of the UE. After receiving the connection information request message, the local network device looks up context of the UE based on the local IP address of the UE, to send, to the SeGW by using a connection information reply message, an identifier that is of a control plane network element to which the UE is currently attached and that is included in the context of the UE.

Manner 3

After receiving the first request message, the SeGW may send, to an HSS, a request message used to request to obtain the identifier of the control plane network element to which the UE is attached, for example, an update location request message, where the message includes a subscriber identity of the UE, for example, a permanent identity and an IMSI. The HSS looks up context of the UE based on the IMSI of the UE. If the UE is already attached to the control plane network element, the HSS stores an identifier of a control plane network element to which the UE is currently attached, to reply to the SeGW with an update location reply message, where the message carries the identifier of the control plane network element to which the UE is attached.

Specifically, a specific manner in which the SeGW obtains the radio access technology indication of the UE may include the following two types.

Manner 1

When forwarding the first request message, the local network device carries the radio access technology indication indicating that a RAT used by the UE is an unlicensed spectrum access technology. After receiving the first request message, the SeGW may obtain the radio access technology indication from the first request message.

Manner 2

When forwarding the first request message, the local network device carries information about a radio access node of the local network, where the information indicates that the radio access node is an unlicensed spectrum radio access node. Therefore, after receiving the first request message, the SeGW may determine, based on the information about the radio access node, that a RAT used by the UE is an unlicensed spectrum access technology, and generate the radio access technology indication.

205. The SeGW sends a second request message to the control plane network element based on the identifier of the control plane network element to which the UE is attached.

In this embodiment of the present invention, the second request message carries a subscriber identity and the radio access technology indication of the UE, and the second request message is used to request to obtain an identifier of the PGW. The subscriber identity may be the temporary identifier or a permanent identity of the UE. The temporary identifier may include a device identifier of the UE and an identifier of the control plane network element to which the UE is attached, for example, an identifier of an MME.

In this embodiment of the present invention, after the SeGW obtains, by using the foregoing approach, the identifier of the control plane network element to which the UE is attached, the SeGW sends the second request message to the control plane network element. The second request message may be a PDN connection establishment request message, or may be an authentication and authorization request message.

Further, the second request message may further carry an identifier indicating whether the local network is a trusted network or an untrusted network, an identifier of a service provider of the local network, a roaming consortium identifier, and the like. This is not limited in this embodiment of the present invention.

206. The control plane network element receives the second request message, and sends an identifier of a PGW to the SeGW based on a subscriber identity and the radio access technology indication.

In a specific implementation, a specific manner in which the control plane network element sends the identifier of the PGW to the SeGW based on the subscriber identity and the radio access technology indication may be:

obtaining subscription data of the UE based on the subscriber identity, performing APN authorization based on the subscription data and the radio access technology indication, and finally sending an identifier of a data gateway corresponding to the successfully-authorized APN to the security gateway.

In this embodiment of the present invention, after receiving the second request message, the control plane network element looks up context of the UE based on the subscriber identity of the UE, for example, a temporary identifier, to obtain the subscription data of the UE, and determines, based on an indication of a RAT that is in the subscription data and that is allowed to be used by the UE, whether to allow the UE to access from a network using an unlicensed spectrum. If the control plane network element allows the UE to access from a network using an unlicensed spectrum, authorization performed on a requested APN or a default APN succeeds. If the authorization of the APN succeeds, the control plane network element selects a corresponding PGW for the successfully-authorized APN, to send an identifier of the selected PGW to the SeGW. If the authorization of the APN fails, the control plane network element replies with a connection rejection message or an authentication and authorization failure message, or adds a failure cause to a connection establishment reply message or an authentication and authorization reply message and sends the message to the SeGW.

It should be noted that, the identifier of the PGW corresponding to the successfully-authorized APN may be understood as an IP address or an FQDN of a PGW that supports an APN requested by or a service type of the UE. The SeGW may be obtained from the control plane network element of the UE. This is not limited in this embodiment of the present invention.

Further, a specific manner in which the control plane network element performs the APN authorization based on the subscription data and the radio access technology indication may include any one of the following types.

Manner 1

If the second request message carries an APN requested by the UE, where the requested APN is an APN in the radio access technology indication, the control plane network element determines whether the subscription data includes the radio access technology indication, and if the subscription data includes the radio access technology indication, the control plane network element determines that the requested APN is successfully authorized, or if the subscription data does not include the radio access technology indication, the control plane network element determines that the requested APN fails to be authorized.

Manner 2

If the second request message does not carry an APN requested by the UE, the control plane network element determines whether the subscription data includes the radio access technology indication, and if the subscription data includes the radio access technology indication, the control plane network element determines that a default APN in the subscription data is successfully authorized, or if the subscription data does not include the radio access technology indication, the control plane network element determines that the default APN in the subscription data fails to be authorized.

Further, if the second request message carries the APN requested by the UE, and the second request message carries the characteristic information of the local network, for example, information about whether the local network is a trusted network or an untrusted network, an identifier of a service provider or a roaming consortium identifier of the local network, or a security authentication mode used by the local network. The control plane network element determines, based on the characteristic information of the local network and the subscription data, whether the foregoing APN can be authorized, that is, determines whether the characteristic information of the local network matches an authorization condition of the requested APN. If the second request message does not carry the APN requested by the UE, the control plane network element may determine whether the default APN can be authorized, that is, determine, based on the characteristic information of the local network and the subscription data, whether a characteristic of the local network matches an authorization condition of the default APN.

For example, assuming that the local network is a trusted network, a belonging service provider is A, the control plane network element may determine whether an authorization condition of a subscription APN in the subscription data allows an access from the trusted network, or whether an access from a local network deployed by the service provider A is allowed, or whether an access from a local network using a RAT of an unlicensed spectrum is allowed. The control plane network element may further determine, based on the authorization condition of the subscription APN in the subscription data, whether to allow the UE to access at a current moment, or the like. If the authorization condition is met, the control plane network element determines that the subscription APN is an authorization APN, or determines that authorization of the subscription APN succeeds.

In a feasible implementation, after authorization of the APN succeeds, the control plane network element may further send the successfully-authorized APN (including an APN that is requested by the UE and that is successfully authorized or a default APN) to the SeGW, so that the SeGW subsequently performs control based on the successfully-authorized APN.

In another feasible implementation, a specific manner in which the control plane network element sends the identifier of the PGW corresponding to the successfully-authorized APN to the SeGW may include at least one of the following types.

Manner 1

The first request message sent by the UE includes location information of the UE, and the second request message sent by the SeGW to the control plane network element carries the location information of the UE, so that after performing authorization on an APN, the control plane network element may send, to the SeGW based on the location information of the UE, an identifier of a PGW that is in PGWs corresponding to the successfully-authorized APN and that is closest to the UE.

Manner 2

The control plane network element may obtain load information of each PGW, and after authorization performed on an APN succeeds, send, to the SeGW based on the load information of each PGW, an identifier of a PGW that is in PGWs corresponding to the successfully-authorized APN and whose load is the lightest.

In still another feasible implementation, if the control plane network element determines that the UE is currently in a moving state, and a requested PDN connection needs mobility, that is, the UE needs to ensure service continuity when moving, when the control plane network element sends an identifier of the PGW to the SeGW, the control plane network element may further send an indication message to the SeGW. The indication message is used to indicate that the SeGW needs to feed back connection information about a session channel connection established with the PGW. The indication message may be an ACK-needed indication, or may be an HO-supported indication, or may further be a service continuity indication. This is not limited in this embodiment of the present invention.

After the SeGW receives the indication message and establishes the session channel connection to the PGW, the SeGW sends a feedback message of the indication message, where the feedback message carries the connection information. Alternatively, a reply message that is of a third request message sent by the SeGW to the control plane network element (that is, a PDN connection establishment reply message) carries the connection information.

The connection information includes at least one of a tunnel endpoint identifier IEID, an IP address, QoS, or the like of the UE, that the PGW allocates to a current PDN connection (or a session channel connection).

207. The SeGW receives the identifier of the PGW, and sends a third request message to the PGW based on the identifier of the PGW.

In this embodiment of the present invention, after obtaining an identifier of the PGW, the SeGW may send, based on the identifier of the PGW, the third request message to a corresponding PGW. The third request message may be a session establishment request message and is used to request to establish a session channel connection to the PGW.

Further, when sending the session establishment request message, the SeGW further sets a type of a RAT used by the UE to an unlicensed spectrum access technology, to send the type of the RAT with the session establishment request message to the PGW. The SeGW further allocates a bandwidth, a QoS parameter, and the like to the session channel connection.

208. The PGW receives the third request message, and establishes a session channel connection to the SeGW.

In this embodiment of the present invention, after receiving the second request message, the PGW establishes a session channel connection to the SeGW. In addition, the PGW allocates an IP address to the UE, and allocates a tunnel, a QoS parameter, and the like for the PDN connection, and records that the current PDN connection is an unlicensed spectrum access.

209. After the session channel connection is successfully established, the SeGW receives a response from the PGW of establishing the session channel connection to the SeGW based on the third request message.

210. The SeGW replies the UE with a response message of the first request message.

In this embodiment of the present invention, after establishment of the session channel connection between the PGW and the SeGW is completed, the SeGW replies the UE with an IKE_AUTH reply message, to complete establishment of a secure channel connection between the UE and the SeGW, and therefore a PDN connection of the UE is completed.

In this embodiment of the present invention, after the home network side (the control plane network element and the PGW) successfully establishes a PDN connection for the UE, the SeGW replies the UE with a response message of the first request message.

Specifically, the SeGW may directly interact with the UE by using an IKEv2 message, or the SeGW may reply to the local network device with a PDN connection reply message, and the local network device forwards the PDN connection reply message to the UE. The PDN connection reply message includes an IKE_AUTH reply message.

It can be learned that, in the method described in FIG. 2, the EPS system may implement access authorization that the UE is attached to the home network from the unlicensed spectrum access node, and when there is an EPC service demand, the UE actively triggers a PDN connection establishment procedure, so that a PDN connection is established for the UE only when the UE has a demand after the UE is attached to the home network, thereby avoiding occupation of EPC network resources, and improving utilization of the EPC network resources. Further, in a process of establishing a PDN connection for the UE, the UE directly establishes a secure channel with the SeGW, and then the SeGW searches for a control plane network element. In this way, the UE and the SeGW may communicate with each other by using the secure channel. A local network deployed by a third party cannot see communication content, and therefore an operator service is protected.

Based on the system architecture shown in FIG. 1, an embodiment of the present invention discloses a schematic structural diagram of a security gateway. FIG. 3 is the schematic structural diagram of the security gateway according to this embodiment of the present invention. A SeGW 300 described in FIG. 3 may be applied to the foregoing method embodiment. As shown in FIG. 3, the SeGW 300 may include a transceiver module 301 and a processing module 302.

The transceiver module 301 is configured to: when UE accesses from a local network using an unlicensed spectrum, receive a first request message sent by a local network device. The first request message is sent by the UE to the local network device, to request to establish a PDN connection for the UE. The PDN connection of the UE includes a secure channel connection between the UE and the SeGW 300 and a session channel connection between the SeGW 300 and a PGW.

The processing module 302 is configured to: obtain a radio access technology indication of the UE; and obtain an identifier of a control plane network element to which the UE is attached, where the radio access technology indication is used to indicate that a radio access technology used by the UE is an unlicensed spectrum access technology.

The transceiver module 301 is further configured to send a second request message to the control plane network element based on the identifier of the control plane network element to which the UE is attached, where the second request message carries a subscriber identity and the radio access technology indication of the UE, and the second request message is used to request to obtain an identifier of the PGW.

The transceiver module 301 is further configured to receive the identifier that is of the PGW and that is returned by the control plane network element based on the subscriber identity and the radio access technology indication.

The transceiver module 301 is further configured to send, based on the identifier of the PGW, a third request message to a corresponding PGW. The third request message is used to establish a session channel connection between the SeGW 300 and the PGW.

The transceiver module 301 is further configured to receive a response from the PGW of establishing the session channel connection to the SeGW 300 based on the third request message.

In this embodiment of the present invention, the first request message may be an APN connection request message or may be a PDN connection request message. This is not limited in this embodiment of the present invention. The second request message may be a PDN connection establishment request message. The third request message may be a session establishment request message. After receiving the second request message, the PGW establishes a session channel connection to the SeGW 300. In addition, the PGW allocates an IP address to the UE, and allocates a tunnel, QoS, and the like for the PDN connection, and records that the current PDN connection is an unlicensed spectrum access.

In a feasible implementation, a specific manner in which the processing module 302 obtains the radio access technology indication of the UE may include the following two types.

Manner 1

When forwarding the first request message, the local network device carries the radio access technology indication indicating that a RAT used by the UE is an unlicensed spectrum access technology. After the transceiver module 301 receives the first request message, the processing module 302 may obtain the radio access technology indication from the first request message.

Manner 2

When forwarding the first request message, the local network device carries information about a radio access node of the local network, where the information indicates that the radio access node is an unlicensed spectrum radio access node. Therefore, after the transceiver module 301 receives the first request message, the processing module 302 may determine, based on the information about the radio access node, that a RAT used by the UE is an unlicensed spectrum access technology, and generate the radio access technology indication.

In another feasible implementation, a specific manner in which the processing module 302 obtains the identifier of the control plane network element to which the UE is attached may include the following several types.

Manner 1

When forwarding the first request message, the local network device carries a temporary identifier allocated by a home network to the UE, where the temporary identifier includes the identifier of the control plane network element to which the UE is attached. After the transceiver module 301 receives the first request message, the processing module 302 may obtain the identifier of the control plane network element to which the UE is attached from the temporary identifier. Alternatively, when forwarding the first request message, the local network device directly carries the identifier of the control plane network element to which the UE is attached, and the processing module 302 directly obtains the identifier of the control plane network element to which the UE is attached from the first request message.

Manner 2

When forwarding the first request message, the local network device carries a local IP address allocated by the local network device to the UE. After receiving the first request message, the transceiver module 301 may send, to the local network device, a request message used to request to obtain the identifier of the control plane network element to which the UE is attached, for example, a connection information request message, where the message carries the local IP address of the UE. After receiving the connection information request message, the local network device looks up context of the UE based on the local IP address of the UE, to send, to the SeGW 300 by using a connection information reply message, an identifier that is of a control plane network element to which the UE is currently attached and that is included in the context of the UE.

Manner 3

After receiving the first request message, the transceiver module 301 may send, to an HSS, a request message used to request to obtain the identifier of the control plane network element to which the UE is attached, for example, an update location request message, where the message includes a subscriber identity of the UE, for example, a permanent identity and an IMSI. The HSS looks up context of the UE based on the IMSI of the UE. If the UE is already attached to the control plane network element, the HSS stores an identifier of a control plane network element to which the UE is currently attached, to reply to the SeGW 300 with an update location reply message, where the message carries the identifier of the control plane network element to which the UE is attached.

In still another feasible implementation, the transceiver module 301 is further configured to: receive an indication message sent by the control plane network element; and send, after establishment of the session channel connection between the SeGW 300 and the PGW is completed, connection information of the session channel connection established with the PGW to the control plane network element.

The indication message is used to instruct the SeGW 300 to feed back a result of establishing the session channel connection to the PGW. The connection information includes at least one of a TEID, an IP address, or QoS of the UE that are allocated by the PGW to the session channel connection (or in other words, a current PDN connection).

In still another feasible implementation, the receiving, by the transceiver module 301, the identifier that is of the PGW and that is returned by the control plane network element based on the subscriber identity and the radio access technology indication includes:

if the first request message carries an APN requested by the UE, where the requested APN is an APN in the radio access technology indication, and the second request message sent by the transceiver module 301 to the control plane network element also carries the requested APN, receiving, by the transceiver module 301, an APN identifier that is returned by the control plane network element after the control plane network element performs authorization on the requested APN based on the subscriber identity and that is of an APN corresponds to the successfully-authorized APN; or

if the first request message does not carry an APN requested by the UE, receiving, by the transceiver module 301, an APN identifier that is returned by the control plane network element based on the subscriber identity and the radio access technology indication and that corresponds to a default APN in subscription data of the UE.

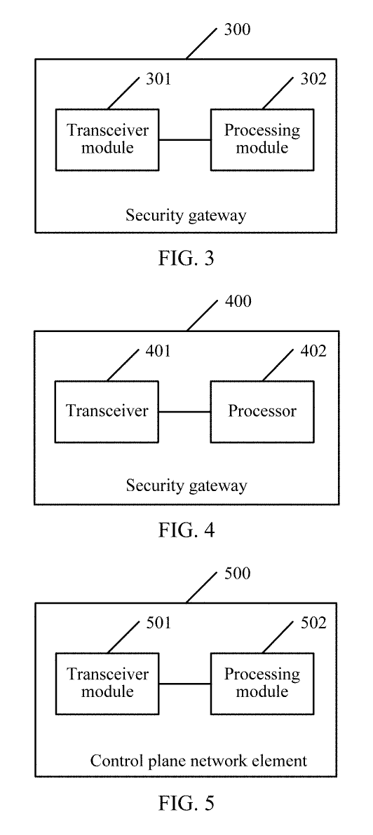

Based on the system architecture shown in FIG. 1, an embodiment of the present invention discloses another schematic structural diagram of a security gateway. FIG. 4 is the schematic structural diagram of the another security gateway according to this embodiment of the present invention. A SeGW 400 described in FIG. 4 may be applied to the foregoing method embodiment. As shown in FIG. 4, the SeGW 400 may include a transceiver 401 and a processor 402.

The transceiver 401 is configured to: when UE accesses from a local network using an unlicensed spectrum, receive a first request message sent by a local network device. The first request message is sent by the UE to the local network device, to request to establish a PDN connection for the UE. The PDN connection of the UE includes a secure channel connection between the UE and the SeGW 400 and a session channel connection between the SeGW 400 and a PGW.

The processor 402 is configured to: obtain a radio access technology indication of the UE; and obtain an identifier of a control plane network element to which the UE is attached, where the radio access technology indication is used to indicate that a radio access technology used by the UE is an unlicensed spectrum access technology.

The transceiver 401 is further configured to send a second request message to the control plane network element based on the identifier of the control plane network element to which the UE is attached, where the second request message carries a subscriber identity and the radio access technology indication of the UE, and the second request message is used to request to obtain an identifier of the PGW.

The transceiver 401 is further configured to receive the identifier that is of the PGW and that is returned by the control plane network element based on the subscriber identity and the radio access technology indication.

The transceiver 401 is further configured to send, based on the identifier of the PGW, a third request message to a corresponding PGW. The third request message is used to establish a session channel connection between the SeGW 400 and the PGW.

The transceiver 401 is further configured to receive a response from the PGW of establishing the session channel connection to the SeGW 400 based on the third request message.

In this embodiment of the present invention, the first request message may be an APN connection request message or may be a PDN connection request message. This is not limited in this embodiment of the present invention. The second request message may be a PDN connection establishment request message. The third request message may be a session establishment request message. After receiving the second request message, the PGW establishes a session channel connection to the SeGW 400. In addition, the PGW allocates an IP address to the UE, and allocates a tunnel, QoS, and the like for the PDN connection, and records that the current PDN connection is an unlicensed spectrum access.

In a feasible implementation, a specific manner in which the processor 402 obtains the radio access technology indication of the UE may include the following two types.

Manner 1

When forwarding the first request message, the local network device carries the radio access technology indication indicating that a RAT used by the UE is an unlicensed spectrum access technology. After the transceiver 401 receives the first request message, the processor 402 may obtain the radio access technology indication from the first request message.

Manner 2

When forwarding the first request message, the local network device carries information about a radio access node of the local network, where the information indicates that the radio access node is an unlicensed spectrum radio access node. Therefore, after the transceiver 401 receives the first request message, the processor 402 may determine, based on the information about the radio access node, that a RAT used by the UE is an unlicensed spectrum access technology, and generate the radio access technology indication.

In another feasible implementation, a specific manner in which the transceiver 401 obtains the identifier of the control plane network element to which the UE is attached may include the following several types.

Manner 1

When forwarding the first request message, the local network device carries a temporary identifier allocated by a home network to the UE, where the temporary identifier includes the identifier of the control plane network element to which the UE is attached. After the transceiver 401 receives the first request message, the processor 402 may obtain the identifier of the control plane network element to which the UE is attached from the temporary identifier. Alternatively, when forwarding the first request message, the local network device directly carries the identifier of the control plane network element to which the UE is attached, and the processor 402 directly obtains the identifier of the control plane network element to which the UE is attached from the first request message.

Manner 2

When forwarding the first request message, the local network device carries a local IP address allocated by the local network device to the UE. After receiving the first request message, the transceiver 401 may send, to the local network device, a request message used to request to obtain the identifier of the control plane network element to which the UE is attached, for example, a connection information request message, where the message carries the local IP address of the UE. After receiving the connection information request message, the local network device looks up context of the UE based on the local IP address of the UE, to send, to the SeGW 400 by using a connection information reply message, an identifier that is of a control plane network element to which the UE is currently attached and that is included in the context of the UE.

Manner 3

After receiving the first request message, the transceiver 401 may send, to an HSS, a request message used to request to obtain the identifier of the control plane network element to which the UE is attached, for example, an update location request message, where the message includes a subscriber identity of the UE, for example, a permanent identity and an IMSI. The HSS looks up context of the UE based on the IMSI of the UE. If the UE is already attached to the control plane network element, the HSS stores an identifier of a control plane network element to which the UE is currently attached, to reply to the SeGW 400 with an update location reply message, where the message carries the identifier of the control plane network element to which the UE is attached.

In still another feasible implementation, the transceiver 401 is further configured to: receive an indication message sent by the control plane network element; and send, after establishment of the session channel connection between the SeGW 400 and the PGW is completed, connection information of the session channel connection established with the PGW to the control plane network element.

The indication message is used to instruct the SeGW 400 to feed back a result of establishing the session channel connection to the PGW. The connection information includes at least one of a TEID, an IP address, or QoS of the UE that are allocated by the PGW to the session channel connection (or in other words, a current PDN connection).

In still another feasible implementation, the receiving, by the transceiver 401, the identifier that is of the PGW and that is returned by the control plane network element based on the subscriber identity and the radio access technology indication includes:

if the first request message carries an APN requested by the UE, where the requested APN is an APN in the radio access technology indication, and the second request message sent by the transceiver 401 to the control plane network element also carries the requested APN, receiving, by the transceiver 401, an APN identifier that is returned by the control plane network element after the control plane network element performs authorization on the requested APN based on the subscriber identity and that is of an APN corresponds to the successfully-authorized APN; or

if the first request message does not carry an APN requested by the UE, receiving, by the transceiver 401, an APN identifier that is returned by the control plane network element based on the subscriber identity and the radio access technology indication and that corresponds to a default APN in subscription data of the UE.

It can be learned that, in the SeGW described in FIG. 3 and FIG. 4, after the UE is attached to the home network from the local network using the unlicensed spectrum, if the UE requests an EPC service, after the SeGW receives the PDN connection request message of the UE, the SeGW establishes a secure channel with the UE, and obtains, by using the control plane network element, a PGW corresponding to the APN requested by the UE or the default APN, and establishes a session channel with the PGW, so that the PDN connection is established for the UE. According to this embodiment of the present invention, after the UE is attached to the home network, an EPS system establishes a PDN connection for the UE only when the UE has a demand, thereby avoiding occupation of EPC network resources, and improving utilization of the EPC network resources. Further, in a process of establishing a PDN connection for the UE, the UE directly establishes a secure channel with the SeGW, and then the SeGW searches for a control plane network element. In this way, the UE and the SeGW may communicate with each other by using the secure channel. A local network deployed by a third party cannot see communication content, and therefore an operator service is protected.

Based on the system architecture shown in FIG. 1, an embodiment of the present invention discloses a schematic structural diagram of a control plane network element. FIG. 5 is the schematic structural diagram of the control plane network element according to this embodiment of the present invention. A control plane network element 500 described in FIG. 5 may be applied to the foregoing method embodiment. As shown in FIG. 5, the control plane network element 500 may include the following transceiver module 501 and processing module 502.

The transceiver module 501 is configured to: when UE is attached to a home network of the UE from a local network using an unlicensed spectrum, receive a second request message sent by a security gateway. The second request message is used to request to obtain an identifier of a PGW, and the second request message carries a subscriber identity and a radio access technology indication of the UE. The radio access technology indication is used to indicate that a radio access technology used by the UE is an unlicensed spectrum access technology. The second request message is sent to the control plane network element 500 by the SeGW after the SeGW receives a first request message of the UE and establishes a secure channel connection to the UE. The first request message is used to request to establish a PDN connection for the UE, where the PDN connection includes a secure channel connection and a session channel connection.

The transceiver module 501 is further configured to: send an identifier of the PGW to the SeGW based on the subscriber identity and the radio access technology indication, so that the SeGW establishes a session channel connection to a PGW identified by an identifier of the PGW corresponding to the APN.

In this embodiment of the present invention, the first request message may be an APN connection request message or may be a PDN connection request message. This is not limited in this embodiment of the present invention.

In this embodiment of the present invention, when the PGW establishes the session channel connection to the SeGW, the PGW allocates an IP address to the UE, and allocates a tunnel, QoS, and the like to the PDN connection, and records that the current PDN connection is an unlicensed spectrum access.

In a feasible implementation, a specific manner in which the transceiver module 501 sends the identifier of the PGW to the SeGW based on the subscriber identity and the radio access technology indication may be:

obtaining subscription data of the UE based on the subscriber identity;

performing APN authorization based on the subscription data and the radio access technology indication by using the processing module 502; and

sending an identifier of a PGW corresponding to the successfully-authorized APN to the SeGW.

In a specific implementation, a specific manner in which the processing module 502 performs the APN authorization based on the subscription data and the radio access technology indication may include any one of the following types.

Manner 1

If the second request message carries an APN requested by the UE, where the requested APN is an APN in the radio access technology indication, the processing module 502 determines whether the subscription data includes the radio access technology indication, and if the subscription data includes the radio access technology indication, the processing module 502 determines that the requested APN is successfully authorized, or if the subscription data does not include the radio access technology indication, the processing module 502 determines that the requested APN fails to be authorized.

Manner 2

If the second request message does not carry an APN requested by the UE, the processing module 502 determines whether the subscription data includes the radio access technology indication, and if the subscription data includes the radio access technology indication, the processing module 502 determines that a default APN in the subscription data is successfully authorized, or if the subscription data does not include the radio access technology indication, the processing module 502 determines that the default APN in the subscription data fails to be authorized.

In another feasible implementation, the transceiver module 501 is further configured to send the successfully-authorized APN to the SeGW, so that the SeGW subsequently performs control based on the successfully-authorized APN.

In still another feasible implementation, a specific manner in which the transceiver module 501 sends the identifier of the PGW corresponding to the successfully-authorized APN to the SeGW may include the following two types.

Manner 1

If the third request message carries location information of the UE, after authorization performed by the processing module 502 on the APN succeeds, the transceiver module 501 may send, to the SeGW based on the location information of the UE, an identifier of a PGW that is in PGWs corresponding to the successfully-authorized APN and that is closest to the UE.

Manner 2

The processing module 502 may obtain load information of each PGW, and after authorization performed on an APN succeeds, the transceiver module 501 sends, to the SeGW based on the load information of each PGW, an identifier of a PGW that is in PGWs corresponding to the successfully-authorized APN and whose load is the lightest.

The identifier of the PGW that is closest to the UE or whose load is the lightest and that is in the PGWs corresponding to the successfully-authorized APN is sent to the SeGW, so that the SeGW establishes a session channel connection to the PGW that is closest to the UE or whose load is the lightest, and therefore utilization of network resources can be improved.

In still another feasible implementation, the transceiver module 501 is further configured to send an indication message to the SeGW, where the indication message is used to instruct the SeGW to feed back a result of establishing the session channel connection to the PGW.

The transceiver module 501 is further configured to receive connection information of the session channel connection sent by the SeGW after the SeGW establishes the session channel connection to the PGW.

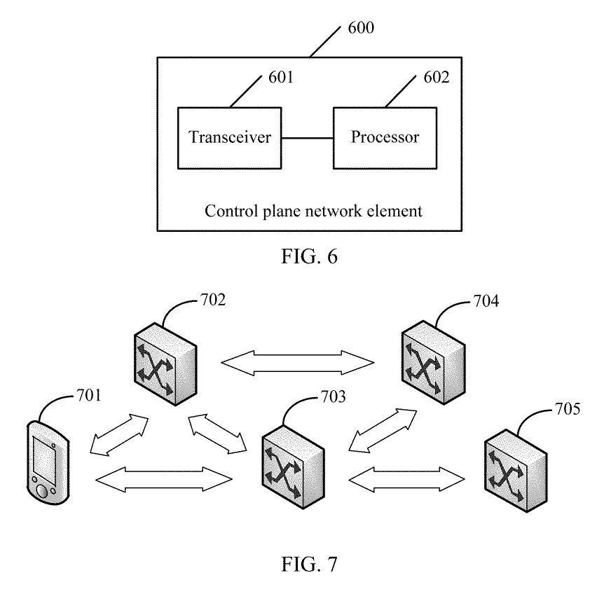

Based on the system architecture shown in FIG. 1, an embodiment of the present invention discloses another schematic structural diagram of a control plane network element. FIG. 6 is a schematic structural diagram of another control plane network element according to an embodiment of the present invention. A control plane network element 600 described in FIG. 6 may be applied to the foregoing method embodiment. As shown in FIG. 6, the control plane network element 600 may include the following transceiver 601 and processor 602.

The transceiver 601 is configured to: when UE is attached to a home network of the UE from a local network using an unlicensed spectrum, receive a second request message sent by a security gateway. The second request message is used to request to obtain an identifier of a PGW, and the second request message carries a subscriber identity and a radio access technology indication of the UE. The radio access technology indication is used to indicate that a radio access technology used by the UE is an unlicensed spectrum access technology. The second request message is sent to the control plane network element 600 by the SeGW after the SeGW receives a first request message of the UE and establishes a secure channel connection to the UE. The first request message is used to request to establish a PDN connection for the UE, where the PDN connection includes a secure channel connection and a session channel connection.

The transceiver 601 is further configured to: send an identifier of the PGW to the SeGW based on the subscriber identity and the radio access technology indication, so that the SeGW establishes a session channel connection to a PGW identified by an identifier of the PGW corresponding to the APN.

In this embodiment of the present invention, the first request message may be an APN connection request message or may be a PDN connection request message. This is not limited in this embodiment of the present invention.

In this embodiment of the present invention, when the PGW establishes the session channel connection to the SeGW, the PGW allocates an IP address to the UE, and allocates a tunnel, QoS, and the like to the PDN connection, and records that the current PDN connection is an unlicensed spectrum access.

In a feasible implementation, a specific manner in which the transceiver 601 sends the identifier of the PGW to the SeGW based on the subscriber identity and the radio access technology indication may be:

obtaining subscription data of the UE based on the subscriber identity;

performing APN authorization based on the subscription data and the radio access technology indication by using the processor 602; and

sending an identifier of a PGW corresponding to the successfully-authorized APN to the SeGW.

In a specific implementation, a specific manner in which the processor 602 performs the APN authorization based on the subscription data and the radio access technology indication may include any one of the following types.

Manner 1

If the second request message carries an APN requested by the UE, where the requested APN is an APN in the radio access technology indication, the processor 602 determines whether the subscription data includes the radio access technology indication, and if the subscription data includes the radio access technology indication, the processor 602 determines that the requested APN is successfully authorized, or if the subscription data does not include the radio access technology indication, the processor 602 determines that the requested APN fails to be authorized.

Manner 2

If the second request message does not carry an APN requested by the UE, the processor 602 determines whether the subscription data includes the radio access technology indication, and if the subscription data includes the radio access technology indication, the processor 602 determines that a default APN in the subscription data is successfully authorized, or if the subscription data does not include the radio access technology indication, the processor 602 determines that the default APN in the subscription data fails to be authorized.

In another feasible implementation, the transceiver 601 is further configured to send the successfully-authorized APN to the SeGW, so that the SeGW subsequently performs control based on the successfully-authorized APN.

In still another feasible implementation, a specific manner in which the transceiver 601 sends the identifier of the PGW corresponding to the APN to the SeGW may include the following two types.

Manner 1

If the third request message carries location information of the UE, after authorization performed by the processor 602 on the APN succeeds, the transceiver 601 may send, to the SeGW based on the location information of the UE, an identifier of a PGW that is in PGWs corresponding to the successfully-authorized APN and that is closest to the UE.

Manner 2

The processor 602 may obtain load information of each PGW, and after authorization performed on an APN succeeds, the transceiver 601 sends, to the SeGW based on the load information of each PGW, an identifier of a PGW that is in PGWs corresponding to the successfully-authorized APN and whose load is the lightest.

The identifier of the PGW that is closest to the UE or whose load is the lightest and that is in the PGWs corresponding to the successfully-authorized APN is sent to the SeGW, so that the SeGW establishes a session channel connection to the PGW that is closest to the UE or whose load is the lightest, and therefore utilization of network resources can be improved.

In still another feasible implementation, the transceiver 601 is further configured to send an indication message to the SeGW, where the indication message is used to instruct the SeGW to feed back a result of establishing the session channel connection to the PGW.

The transceiver 601 is further configured to receive connection information of the session channel connection sent by the SeGW after the SeGW establishes the session channel connection to the PGW.

It can be learned that, in the control plane network element described in FIG. 5 and FIG. 6, after receiving a PDN connection establishment request message sent by the SeGW, the control plane network element may first perform authorization on an APN requested by the UE, and send, only when the authorization succeeds, an identifier of a PGW corresponding to the successfully-authorized APN to the SeGW. Therefore, the SeGW establishes the session channel connection to the PGW, so that after the UE is attached to a home network, a PDN connection is established for the UE only when the UE has a demand, thereby avoiding occupation of EPC network resources, and improving utilization of the EPC network resources.

Based on the system architecture shown in FIG. 1, an embodiment of the present invention discloses a system for establishing a PDN connection. FIG. 7 is a schematic structural diagram of the system for establishing a PDN connection according to this embodiment of the present invention. As shown in FIG. 7, the system may include UE 701, a local network device 702, an SeGW 703, a control plane network element 704, and a PGW 705.

The local network device 702 is a service device of a local network using an unlicensed spectrum, may include an MME or an AAA server, or the like, and may further include an unlicensed spectrum access node, that is, a base station or an access point using an unlicensed spectrum. This is not limited in this embodiment of the present invention.

The UE 701 is attached to a home network by initiating an attach procedure by using the local network using the unlicensed spectrum (specifically, by using a local network device 702, a control plane network element 704, an HSS, and the like). After the UE is successfully attached, if the UE 701 has an EPC service (that is, a core network service) demand, the UE 701 sends a first request message to the local network device 702. The first request message carries an identifier of an SeGW 703 and an identifier of the control plane network element 704 to which the UE 701 is attached. Optionally, the PDN connection establishment request message may further include an APN requested by the UE 701.

After receiving the first request message, the local network device 702 forwards the first request message to the corresponding SeGW 703. The SeGW 703 obtains the radio access technology indication of the UE after receiving the first request message, where the radio access technology indication is used to indicate that the radio access technology used by the UE 701 is an unlicensed spectrum access technology, and obtains an identifier of the control plane network element 704.

Further, the SeGW 703 sends a second request message to the control plane network element 704 based on the identifier of the control plane network element 704. The second request message carries the subscriber identity and the radio access technology indication to the UE 701. If the second request message carries the APN requested by the UE 701, after the control plane network element 704 obtains subscription data of the UE 701 based on the subscriber identity, the control plane network element 704 may perform, based on the subscription data and the radio access technology indication, authorization on the APN requested by the UE 701. If the PDN connection establishment request message does not carry the APN requested by the UE 701, the control plane network element 704 may perform authorization on a default APN of the UE 701 based on the subscription data and the radio access technology indication. If the APN is successfully authorized, the control plane network element 704 may send an identifier of the PGW 705 corresponding to the successfully-authorized APN to the SeGW 703. If the APN fails to be authorized, the control plane network element 704 returns a rejection message.

The SeGW 703 sends a third request message to the PGW 705 based on the identifier of the PGW 705 corresponding to the successfully-authorized APN, where the third request message carries the radio access technology indication. The SeGW 703 receives a response from the PGW of establishing the session channel connection to the SeGW 703 based on the third request message. The PGW 705 establishes the session channel connection to the SeGW 703, and allocates an IP address to the UE 701 and records that a PDN connection of the UE 701 is an unlicensed spectrum access. At this point, the SeGW 703 replies the UE with an APN connection reply message, so that the PDN connection to the UE 701 is completed.

When the PDN connection is established for the UE 701, the SeGW 703 and the UE 701 may communicate with each other by using an established secure channel.

It can be learned that, in the system described in FIG. 7, access authorization of accessing, by the UE, the home network from the unlicensed spectrum node may be implemented, and when there is an EPC service demand, the UE actively triggers a PDN connection establishment procedure, so that a PDN connection is established for the UE only when the UE has a demand after the UE is attached to the home network, thereby avoiding occupation of EPC network resources, and improving utilization of the EPC network resources. Further, in a process of establishing a PDN connection for the UE, the UE directly establishes a secure channel with the SeGW, and then the SeGW searches for a control plane network element. In this way, the UE and the SeGW may communicate with each other by using the secure channel. A local network deployed by a third party cannot see communication content, and therefore an operator service is protected.

It should be noted that, in the foregoing embodiments, the description of each embodiment has respective focuses. For a part that is not described in detail in an embodiment, reference may be made to related descriptions in other embodiments. In addition, a person skilled in the art should also appreciate that all the embodiments described in the specification are example embodiments, and the related actions and modules are not necessarily mandatory to the present invention.

A sequence of the steps of the method in the embodiments of the present invention may be adjusted, and certain steps may also be combined or removed based on an actual demand.

Merging, division, and removing may be performed on the modules in the control plane network element and the security gateway in the embodiments of the present invention according to an actual need.

The control plane network element and the security gateway in the embodiments of the present invention may be implemented by a universal integrated circuit, such as a CPU (Central Processing Unit, central processing unit) or an ASIC (Application Specific Integrated Circuit, application-specific integrated circuit).

A person of ordinary skill in the art may understand that all or some of the processes of the methods in the embodiments may be implemented by a computer program instructing relevant hardware. The program may be stored in a computer readable storage medium. When the program runs, the processes of the methods in the embodiments are performed. The foregoing storage medium may include a magnetic disc, an optical disc, a read-only memory (Read-Only Memory, ROM), a random access memory (Random Access Memory, RAM), or the like.

The method for establishing a PDN connection, the related device, and the system disclosed in the embodiments of the present invention are described in detail above. The principle and implementation of the present invention are described herein through specific examples. The description about the embodiments of the present invention is merely provided to help understand the method and core ideas of the present invention. In addition, a person of ordinary skill in the art can make variations and modifications to the present invention in terms of the specific implementations and application scopes according to the ideas of the present invention. Therefore, the content of specification shall not be construed as a limit to the present invention.

What is claimed is:

1. A method for establishing a public data network PDN connection, applied to an evolved packet system EPS, wherein the method comprises:
when UE accesses from a local network using an unlicensed spectrum, receiving, by a security gateway, a first request message sent by a local network device, wherein the first request message is used to request to establish a public data network PDN connection for the UE;
obtaining, by the security gateway, a radio access technology indication of the UE, wherein the radio access technology indication is used to indicate that a radio access technology used by the UE is an unlicensed spectrum access technology, and obtaining an identifier of a control plane network element to which the UE is attached;
sending, by the security gateway, a second request message to the control plane network element based on the identifier of the control plane network element to which the UE is attached, wherein the second request message carries a subscriber identity and the radio access technology indication of the UE, and the second request message is used to request to obtain an identifier of a data gateway;
receiving, by the security gateway, the identifier that is of the data gateway and that is returned by the control plane network element based on the subscriber identity and the radio access technology indication;
sending, by the security gateway, a third request message to the data gateway based on the identifier of the data gateway, wherein the third request message is used to request to establish a session channel connection between the security gateway and the data gateway; and
receiving, by the security gateway, a response from the data gateway of establishing the session channel connection to the security gateway based on the third request message.

2. The method according to claim 1, wherein the obtaining, by the security gateway, a radio access technology indication of the UE comprises:
if the first request message carries the radio access technology indication of the UE, obtaining, by the security gateway, the radio access technology indication from the first request message; or if the first request message carries radio access node information of the local network, determining, by the security gateway based on the radio access node information, that the radio access technology used by the UE is the unlicensed spectrum access technology, and generating the radio access technology indication.

3. The method according to claim 1, wherein the obtaining, by the security gateway, an identifier of a control plane network element to which the UE is attached comprises:
if the first request message carries a temporary identifier allocated by a home network to the UE, obtaining, by the security gateway from the temporary identifier, the identifier of the control plane network element to which the UE is attached; or if the first request message carries the identifier of the control plane network element to which the UE is attached, obtaining, by the security gateway from the first request message, the identifier of the control plane network element to which the UE is attached.

4. The method according to claim 1, wherein the obtaining, by the security gateway, an identifier of a control plane network element to which the UE is attached comprises:
if the first request message carries a local Internet Protocol IP address allocated by the local network device to the UE, sending, by the security gateway to the local network device, a request message used to obtain the identifier of the control plane network element to which the UE is attached, wherein the request message carries the local IP address; and
receiving, by the security gateway, the identifier that is of the control plane network element to which the UE is attached and that is sent by the local network device based on the local IP address.

5. The method according to claim 1, wherein the obtaining, by the security gateway, an identifier of a control plane network element to which the UE is attached comprises:
sending, by the security gateway to a home subscriber server HSS, a request message used to obtain the identifier of the control plane network element to which the UE is attached, wherein the request message carries the subscriber identity; and
receiving, by the security gateway, the identifier that is of the control plane network element to which the UE is attached and that is sent by the HSS based on the subscriber identity.

6. The method according to claim 1, wherein the receiving, by the security gateway, the identifier that is of the data gateway and that is returned by the control plane network element based on the subscriber identity and the radio access technology indication comprises:
if the first request message carries an access point name APN requested by the UE, wherein the requested APN is an APN in the radio access technology indication, and the second request message carries the requested APN, receiving, by the security gateway, an identifier that is returned by the control plane network element after the control plane network element performs authorization on the requested APN based on the subscriber identity and that is of a data gateway corresponding to the successfully-authorized APN; or
receiving, by the security gateway, an identifier that is returned by the control plane network element based on the subscriber identity and the radio access technology indication and that is of a data gateway corresponding to a default APN in subscription data of the UE.

7. A method for establishing a PDN connection, applied to an EPS, wherein the method comprises:
when the UE accesses from a local network using an unlicensed spectrum, receiving, by a control plane network element, a second request message sent by a security gateway, wherein the second request message carries a subscriber identity and a radio access technology indication of the UE, and the radio access technology indication is used to indicate that a radio access technology used by the UE is an unlicensed spectrum access technology, and the second request message is used to request to obtain an identifier of a data gateway; and
sending, by the control plane network element, the identifier of the data gateway to the security gateway based on the subscriber identity and the radio access technology indication.

8. The method according to claim 7, wherein the sending, by the control plane network element, the identifier of the data gateway to the security gateway based on the subscriber identity and the radio access technology indication comprises:
obtaining, by the control plane network element, subscription data of the UE based on the subscriber identity;
performing, by the control plane network element, APN authorization based on the subscription data and the radio access technology indication; and
sending, by the control plane network element, an identifier of a data gateway corresponding to a successfully-authorized APN to the security gateway.

9. The method according to claim 8, wherein the performing, by the control plane network element, APN authorization based on the subscription data and the radio access technology indication comprises:
if the second request message further carries an APN requested by the UE, wherein the requested APN is an APN in the radio access technology indication, determining, by the control plane network element, whether the subscription data comprises the radio access technology indication, and if the subscription data comprises the radio access technology indication, determining that the requested APN is successfully authorized, or if the subscription data does not comprise the radio access technology indication, determining that the requested APN fails to be authorized; or
determining, by the control plane network element, whether the subscription data comprises the radio access technology indication, and if the subscription data comprises the radio access technology indication, determining that a default APN in the subscription data is successfully authorized, or if the subscription data does not comprise the radio access technology indication, determining that the default APN in the subscription data fails to be authorized.

10. The method according to claim 8, wherein the method further comprises:
sending, by the control plane network element, the successfully-authorized APN to the security gateway.

11. A security gateway, applied to an EPS, wherein the security gateway comprises:
a transceiver module, configured to: when UE accesses from a local network using an unlicensed spectrum, receive a first request message sent by a local network device, wherein the first request message is used to request to establish a PDN connection for the UE;
a processing module, configured to: obtain a radio access technology indication of the UE, wherein the radio access technology indication is used to indicate that a radio access technology used by the UE is an unlicensed spectrum access technology; and obtain an identifier of a control plane network element to which the UE is attached;
the transceiver module is further configured to send a second request message to the control plane network element based on the identifier of the control plane network element to which the UE is attached, wherein the second request message carries a subscriber identity and the radio access technology indication of the UE, and the second request message is used to request to obtain an identifier of a data gateway;
the transceiver module is further configured to receive the identifier that is of the data gateway and that is returned by the control plane network element based on the subscriber identity and the radio access technology indication;
the transceiver module is further configured to send a third request message to the data gateway based on the identifier of the data gateway, wherein the third request message is used to request to establish a session channel connection between the security gateway and the data gateway; and
the transceiver module is further configured to receive a response from the data gateway of establishing the session channel connection to the security gateway based on the third request message.

12. The security gateway according to claim 11, wherein a specific manner in which the processing module obtains the radio access technology indication of the UE is:
if the first request message carries the radio access technology indication of the UE, obtaining the radio access technology indication from the first request message; or if the first request message carries radio access node information of the local network, determining, based on the radio access node information, that a radio access technology used by the UE is an unlicensed spectrum access technology, and generating the radio access technology indication.

13. The security gateway according to claim 11, wherein a specific manner in which the processing module obtains the identifier of the control plane network element to which the UE is attached is:
if the first request message carries a temporary identifier allocated by a home network to the UE, obtaining the identifier of the control plane network element to which the UE is attached from the temporary identifier; or if the first request message carries the identifier of the control plane network element to which the UE is attached, obtaining the identifier of the control plane network element to which the UE is attached from the first request message.

14. The security gateway according to claim 12, wherein a specific manner in which the processing module obtains the identifier of the control plane network element to which the UE is attached is:
if the first request message carries a local Internet Protocol IP address allocated by the local network device to the UE, sending, to the local network device, a request message used to obtain the identifier of the control plane network element to which the UE is attached, wherein the request message carries the local IP address; and
receiving the identifier that is of the control plane network element to which the UE is attached and that is sent by the local network device based on the local IP address.

15. The security gateway according to claim 12, wherein a specific manner in which the processing module obtains the identifier of the control plane network element to which the UE is attached is:
sending, to an HSS, a request message used to obtain the identifier of the control plane network element to which the UE is attached, wherein the request message carries the subscriber identity; and
receiving the identifier that is of the control plane network element to which the UE is attached and that is sent by the HSS based on the subscriber identity.

16. The security gateway according to claim 12, wherein a specific manner in which the transceiver module receives the identifier that is of the data gateway and that is returned by the control plane network element based on the subscriber identity and the radio access technology indication is:
if the first request message carries an APN requested by the UE, wherein the requested APN is an APN in the radio access technology indication, and the second request message carries the requested APN, receiving an identifier that is returned by the control plane network element after the control plane network element performs authorization on the requested APN based on the subscriber identity and that is of a data gateway corresponding to the successfully-authorized APN; or
receiving an identifier that is returned by the control plane network element based on the subscriber identity and the radio access technology indication and that is of a data gateway corresponding to a default APN in subscription data of the UE.

17. A control plane network element, applied to an EPS, wherein the control plane network element comprises:
a transceiver module, configured to: when UE accesses from a local network using an unlicensed spectrum, receive a second request message sent by a security gateway, wherein the second request message carries a subscriber identity and a radio access technology indication of the UE, and the radio access technology indication is used to indicate that a radio access technology used by the UE is an unlicensed spectrum access, and the second request message is used to request to obtain an identifier of a data gateway; and
the transceiver module is further configured to send an identifier of the data gateway to the security gateway based on the subscriber identity and the radio access technology indication.

18. The control plane network element according to claim 17, wherein the control plane network element further comprises a processing module, and a specific manner in which the transceiver module sends the identifier of the data gateway to the security gateway based on the subscriber identity and the radio access technology indication is:
obtaining subscription data of the UE based on the subscriber identity;
performing APN authorization based on the subscription data and the radio access technology indication by using the processing module; and
sending an identifier of a data gateway corresponding to a successfully-authorized APN to the security gateway.

19. The control plane network element according to claim 18, wherein a specific manner in which the processing module performs the APN authorization based on the subscription data and the radio access technology indication is:
if the second request message further carries an APN requested by the UE, wherein the requested APN is an APN in the radio access technology indication, determining whether the subscription data comprises the radio access technology indication, and if the subscription data comprises the radio access technology indication, determining that the requested APN is successfully authorized, or if the subscription data does not comprise the radio access technology indication, determining that the requested APN fails to be authorized; or
determining whether the subscription data comprises the radio access technology indication, and if the subscription data comprises the radio access technology indication, determining that a default APN in the subscription data is successfully authorized, or if the subscription data does not comprise the radio access technology indication, determining that the default APN in the subscription data fails to be authorized.

20. The control plane network element according to claim 17, wherein a specific manner in which the transceiver module sends the identifier of the data gateway corresponding to the successfully-authorized APN to the security gateway is:
if the second request message comprises location information of the UE, sending to the security gateway based on the location information, an identifier of a data gateway that is in data gateways corresponding to the successfully-authorized APN and that is closest to the UE; or
obtaining load information of each data gateway, and sending to the security gateway based on the load information, an identifier of a data gateway that is in data gateways corresponding to the successfully-authorized APN and whose load is the lightest.
